(19) United States
(12) Patent Application Publication
(10) Pub. No.: US 2012/0284072 A1
(43) Pub. Date: Nov. 8, 2012

(54) RAM-IP: A COMPUTERIZED METHOD FOR PROCESS OPTIMIZATION, PROCESS CONTROL, AND PERFORMANCE MANAGEMENT BASED ON A RISK MANAGEMENT FRAMEWORK

(75) Inventors: Salvatore Mazzeo, Weehawken, NJ (US); Elena Kit-Ying Keung-Lee, Flushing, NY (US)

(73) Assignee: Project Risk Analytics, LLC, New York, NY (US)

(21) Appl. No.: 13/442,972

(22) Filed: Apr. 10, 2012

Related U.S. Application Data
(60) Provisional application No. 61/483,124, filed on May 6, 2011.

(51) Int. Cl. G06Q 10/06

(52) U.S. Cl. 705/7.12

(57) ABSTRACT

Risk Analytics Management—Integrated Process (“RAM-IP”), a computerized method for project optimization, process control and performance management based on a risk management framework. A project comprises a plurality of risk sources, e.g., nine, that are managed from Day One by establishing a plurality of risk streams, e.g., 32, that break down the risk at each source. Each risk stream is divided into a plurality of risk control steps, each of which is assigned a risk owner who works with various information inputs to manage a set of control deliverables and to control risk at each source. The project timeline is based on a sequence of critical milestones connected to completion of such control steps, all based on risk assessment and control. Technical, financial and process governance are process integrated. In a complex project, there may be thousands of control deliverables, requiring a software basis for continuous tracking, coordination, and updating.

### RELATIONSHIP TO OTHER APPLICATIONS AND PATENTS

This application draws priority from a pending U.S. Provisional Patent Application Ser. No. 61/483,124, filed May 6, 2011.

### FIELD OF THE INVENTION

The present invention relates to methods for controlling the execution of risk in projects; more particularly, to multivariate risk control methods for such execution; and most particularly, to a computerized method for process optimization, process control, and performance management within an overall risk management structure established at the outset of a complex project having a very large number of activities to be managed.

### BACKGROUND OF THE INVENTION

Prior systems and methods are known for project management. See, for example, Published US Patent Application Nos. 2003/0135399, 2004/0260566, 2005/0114829, and 2008/0255910; and U.S. Pat. Nos. 7,548,883 and 7,593,859. However, these conventional systems and methods typically fail to deliver the financial value or results expected, as they rely on a cumbersome activity based model, which seeks to manually track an overwhelming number of activities and associated interdependencies, many of which are not properly tracked and therefore never met. In addition, risk typically has merely been considered an additional dimension to the multitude of tasks to track and has been dealt with ad hoc as it is perceived to arise; prior art manual methods of integrating risk and associated risk management activities into a conventional process result only in additional information management burdens. None of these prior art methods sequentially maps risk from the inception of the project, and none truly integrates risk assessment and control into every activity.

Recent statistics speak to the ineffectiveness of current project management methods and available software; however, the ability to complete successful projects is crucial for organizations and society. Project expenditures constitute over 20% of GDP in the United States, and the waste of resources and the failure to successfully plan and execute projects can detrimentally impact society. Recent studies have revealed that in 2008 only 32% of projects were completed on time and on budget, delivering the originally intended product features; whereas 44% of projects were completed over budget and with fewer features than originally envisioned; and 24% of projects were never completed and were cancelled. It is believed that poor planning and the lack of understanding of customer requirements are the primary reasons for project waste. Large amounts of money can be lost in projects that are not completed on time or on budget.

Project management at Boeing Aircraft Corp. provides an excellent example of the cost of delays and lack of project coordination and risk management. Boeing executives have reported that approximately 30% of the tasks performed in building an airplane have to be reworked, and ten years after announcement of Boeing's 787 Dreamliner, the aircraft is just now coming to market amid multiple delays and large cost overruns.

Operating units within enterprises are being asked by management to more consistently undertake and report on risk management initiatives and to look for efficiencies to lower their cost basis. Higher predictability of project delivery timelines and costs result directly in higher enterprise value. However, multilayered project requirements make projects very complex to plan and virtually impossible to execute when carried out manually, and involvement of multiple functional teams adds to the complexity of information management and coordination. These challenges include: 1) tracking and updating complex and hard to read activity-based schedules; 2) dealing with inconsistent planning and execution approaches from project-to-project; 3) inconsistent or not fully integrated governance processes; 4) duplications of efforts; 5) unclear ownership and accountability of team members; 6) lack of best practices applications; 7) undefined tactical risk management strategies and 8) ineffective budget, schedule, and risk reporting.

What is needed in the art is a computerized method of project management wherein risk determines all actions and activities. The stability of process and the predictability of outcome for complex projects is enhanced by mapping recurrent and high impact risks from Day One of the project through a project control worksheet and integrated risk registry. Risk management is not merely belatedly integrated into a cumbersome activity-based process; instead, all activities are defined by the identified risks themselves, thereby enabling the user of such a computerized method to easily track the outcome of an activity in the form of deliverables while continually assessing and mitigating risk throughout the life cycle of the project.

It is a principal object of the invention to complete complex projects on time, within budget, and at minimal risk of delay, cost overrun, or failure.

### BRIEF DESCRIPTION OF THE INVENTION

Briefly described, a computerized method in accordance with the present invention for project optimization, process control, and performance management is based on a risk management framework. Such framework allows the project control manager (operator) to map risk from day one by breaking down risk into a plurality of risk sources and risk streams allowing for a sequential analysis of the project development. The operator controls the given risk stream by assigning a set of control steps (risk mitigation activities) with clear risk management strategy, ownership, and impact. In the given control step, the required information input is defined in order for the risk owner to process the control deliverables necessary to satisfy the completion of such control step. A subset of control steps is subjected to technical, process, and financial governance and such control steps are completed after sign-offs are received. The project timeline and the associated tracking and updating of it is now simple and effectively reported to the client. The timeline is graphically represented as a single line (dots or segments representing sequential control steps) of control steps open and to be completed plus a set of critical milestones for interim project achievements, all based on continuous risk assessment and control. For the first time, risk management is neither an additional dimension to the project delivery process nor an appendix, but rather is a starting point on Day One for all project activities.

In a complex project, there will be hundreds if not thousands of control deliverables and significant quantitative analysis of the risk impact, requiring a computer software basis for continuous real-time assessment, tracking, updating, and reporting.

As used herein, the term “project” is not confined to only capital construction projects per se but rather more broadly to any kind of human activity wherein a number of steps may be organized for achievement to reach a desired goal, e.g., development of a new drug, development of a new energy source, organization of a military objective, and the like.

### DESCRIPTION OF THE DRAWINGS

The foregoing and other objects, features, and advantages of the invention, as well as presently preferred embodiments thereof, will become more apparent from a reading of the following description in connection with the accompanying drawings in which:

FIG. 1 is an exemplary flow diagram of RAM-IP in accordance with the present invention showing a 100% risk-based framework for project execution;

FIG. 1a is an exemplary software spreadsheet in accordance with the present invention;

FIG. 2 is an exemplary flow diagram of risk mapping that identifies risk sources and risk streams at Day One;

FIG. 3 is an exemplary flow diagram showing how a risk stream is matched by one or more corresponding control steps;

FIG. 4 is an exemplary flow diagram showing cascading control steps wherein control deliverables from a first control step can become information input for a successor second control step;

FIG. 5 is an exemplary flow diagram showing that a chronological sequence of interleaved control steps may arise from a plurality of risk streams;

FIG. 6 is an exemplary flow diagram for analysis of product and quality, and of cost and time, in terms of impact and contingencies; and

FIG. 7 is an exemplary flow diagram showing governance sign-off on control steps.

### DETAILED DESCRIPTION OF THE INVENTION

RAM-IP is a project optimization, process control, and performance management business method created to enhance stability of process and predictability of outcome for complex design and construction projects. It is a sophisticated yet user friendly tool in response to common business problems that are of concern for senior managers and project leaders of project intensive organizations. RAM-IP is a technological solution to recurring project issues such as: 1) tracking and updating of complex activity-based schedules; 2) inconsistent approach and execution from project to project, 3) inconsistent or not fully integrated governance process, 4) duplication of efforts, 5) unclear ownership and accountability of team members, 6) lack of best practices application; 7) undefined tactical risk management strategies and 8) ineffective budget, schedule and risk reporting.

RAM-IP is best applicable to projects requiring a high degree of cooperation among multifunctional teams; effective decision-making based on internal and external risks; process and variance control; and governance integration.

RAM-IP is a proprietary business method following the vision of a project delivery process driven by risk management. For the first time risk management is a comprehensive approach to project management and not just another marginal dimension or an appendix to the design and construction process. It has been developed with very targeted attention to specific tactical details that make the difference in the process while, at the same time, preserving the approach to project leadership to one that fosters operational leverage and values professionalism.

RAM-IP represents a new paradigm for project management, providing a risk-based approach, wherein risk becomes the starting point, and simplified process tracking, wherein a relatively few critical control steps are tracked versus a myriad of tasks in the prior art.

There are three spheres of RAM-IP: Project Optimization, Process Control, and Performance Management.

Project Optimization is delivering the best possible product within the intended parameters by fully utilizing the allocated resources. Within Project Optimization, Product Focus ensures that the final project characteristics satisfy the initial owner's requirements, deliver what the owner or the owner's internal clients are expecting, and track and report any variations in the design of the product. Risk Based Management makes risk management tactics integral to the project management process by mapping recurrent and high impact risks from Day One and organizing those risks sequentially, tailoring an effective operating framework to deliver a stable project development with predictable outcomes. Best Practices/Standards leverage industry best practices and standards to deliver a first class product in an efficient and effective manner. Dynamic Process works with a process that is flexible and adaptable to change in directions that may come from the owner's fluid business environment.

Process Control is a collection of control tactics established to improve stability of the process and to diminish variability of project outcome. Within Process Control, Alignment of Risk, Control Activity, and Variability identify the given risk and assign the appropriate control tactic with the purpose of reducing the correspondent segment of variability, and introduce the notion that the completion of the prescribed control deliverables is the necessary condition to satisfy a control step. Analytics leverages a powerful valuation platform for all cost management activities, prepares and updates baseline budgets, calculates risk exposures, and determines appropriate contingency levels. Governance identifies functional (technical), process, and financial stakeholders from the owner's team and ensures that the proper sign-offs are in place before accepting design solutions, completing critical process steps, or making financial commitments. Financial Control and Reporting offer a robust cost control process that enables the owner to track, accept, and approve budgeted, committed, and invoiced amounts, and provide a high level of transparency to the process with comprehensive cost reporting and cash flow analysis.

Performance Management provides the project constituents with consistent direction and useful information to generate quality and timely deliverables. Within Performance Management, Collaboration works with the project team from day one to determine the project's competing priorities and to establish a collaborative risk management approach to the project, provides clear directions, and aligns the team efforts to achieve the established project goals. Operational Discipline and Ownership assigns key risk control activities to single project team members with unequivocal responsibility for carrying the specific task, thereby avoiding duplication of efforts and unnecessary reiterations of tasks. Operational Leverage coordinates the skills and the experience of the team members and their respective organizations to foster an environment for creative solutions that work and are commercially viable. Deliverables Quality Assurance identifies all project deliverables as a team from Day One and reviews key deliverables to verify that the quality of information is acceptable.

The following are some of RAM-IP most relevant features and benefits:

Features: RAM-IP allows the project control manager (PCM) to match the project specific risk profile to the model RAM-IP's framework with ease of use and flexibility; align multiple risk mitigation activities per risk stream, establish individual risk mitigation goals, and identify potential impacts; set expectations on the quality and timing of critical deliverables; synchronize deliverables flow with the defined project control steps; calculate contingencies with the assistance of costing techniques and simulation software; and report on project development status, risks, mitigation strategies, and exposures.

Benefits: RAM-IP is a dynamic, comprehensive yet simple process capable of successfully delivering the intended program; the process returns efficiencies and tangible cost reductions; duplication of effort is minimized; the project develops in a stable and predictable way; there are no moving targets; RAM-IP can be introduced to an initiated project at any stage of the lifecycle, although optimally at Day One; program changes can be adsorbed by the process at any time during the life cycle of the project; all team members are led with operational discipline and encouraged to act as risk managers; risks and value opportunities are quantified, registered, and monitored sequentially along the lifecycle of the project; technical, process, and financial governance is process integrated; process is auditable and transparent with relevant decisions that are clearly tracked and recorded; lessons learned from the adopted risk mitigation strategies can be shared with others within the client's organization for training and knowledge sharing.

Elements of a method in accordance with the present invention may be defined as follows:

Project Control Manager (PCM)—the entity responsible for managing the RAM-IP process and the project team's performance during the entire life cycle of the project. The owner can be the PCM.

Project team—composed of the owner representative, project control manager, architect, engineer(s) and constructor(s). Other specialty consultants' deliverables or value contribution activities are integrated through the architect or engineer(s).

Owner—the employee or consultant acting in the role of project executive or project manager; may be assigned by the owner as a single point of contact for the PCM and the other vendors.

Constructor—the general contractor or construction manager engaged as primary builder.

Project development phase—a project duration when a distinct set of programming, design, and construction activities are completed. The identified phases are: programming/due diligence, preconstruction, contracting bid and award, construction administration, and post-construction.

Risk level—the probability of an observed or perceived risk associated with a risk stream.

Risk source—a group or type of risk that presents itself at multiple points during the project development phases.

Risk stream—a risk category assigned to programming and/or design and construction activities utilized by the PCM to sequentially map recurrent and high impact project delivery risks.

Key risk control activity (control step)—action (tactic) taken by the risk owner to perform a specific project control function within a risk stream. Single or multiple key risk control activities are assigned to manage individual risk streams.

Risk owner—the entity primarily responsible to perform the key risk control activity.

Risk strategy—the target risk management strategy, identified by the PCM (in agreement with the project team) and undertaken by the risk owner, consistent with the given key risk control activity.

Internal or external risks—an internal risk is a risk over which the project team has direct control. An external risk is a risk that is not an internal risk. Rarely, key risk control activities are classified as both internal and external risks.

Process Variables—process parameters under control, e.g., product, cost, time, and quality; risk is not a process variable.

Impact—the possible effect of the risk associated with the key risk control activity on the product functional and esthetic characteristics, the final cost of the project, the project schedule, or the quality of both the process and the installation. Impact can be either positive or negative.

Information Input—a set of information deliverables to be provided to the risk owner in order for him or her to produce the associated control deliverables.

Control deliverables—the deliverables generated or verified by the risk owner as being necessary to complete a key risk control activity (control step).

Minimum content requirement—key control deliverable—a subset of control deliverables for which special attention to content is given. Standard forms are distributed to the risk owner for expectation setting and are used by PCM as a guide to check quality and content of information.

Contingencies—additional costs or duration extensions as provisions related to identified impacts.

Baseline budget—an up-to-date budget at the time contingencies are calculated.

Baseline schedule—an up-to-date critical path schedule at the time schedule contingencies are calculated.

Control budget—an accepted, approved, or funded amount deemed sufficient to fully deliver the project. The control budget is the budget of reference for cost control data and other financial metrics.

Control schedule—the accepted or approved duration necessary to fully deliver the project.

Schedule week cost—the cost required to accelerate the schedule by one week.

Total expected cost impact—the total contingencies calculations as output of the simulation process at a selected confidence level.

Updated budget—a revised and up-to-date budget including the newly calculated cost contingencies.

Updated schedule (substantial/final completion)—a revised and up-to-date substantial completion or final completion schedule including the newly calculated duration contingencies.

Financial governance—a stakeholder approval framework that permits the project team to proceed through the project development steps with the required level of approval for funding, vendor commitments (funding appropriations), scope changes, and vendor payments by the owner assigned financial stakeholder(s) (i.e. owner project manager, project control manager and/or other senior managers with appropriate level of approval).

Technical governance—a stakeholder approval or acceptance framework that permits the project team to proceed through the project development steps with the required level of approval on design criteria by the owner assigned technical stakeholders (i.e. owner project manager, and head of design management and/or head of engineering).

Process governance—a stakeholder approval or acceptance framework that permits the project team to proceed through the project development steps with the required level of approval on process operating standards by the owner-assigned process stakeholder(s) (i.e. sourcing representative, property operations representative and/or enterprise risk manager).

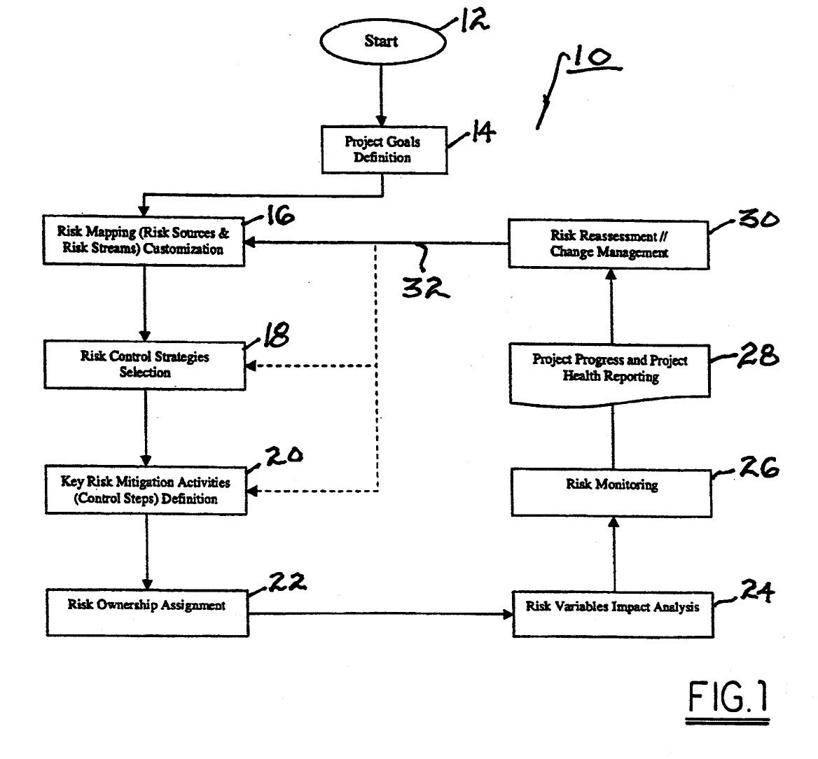

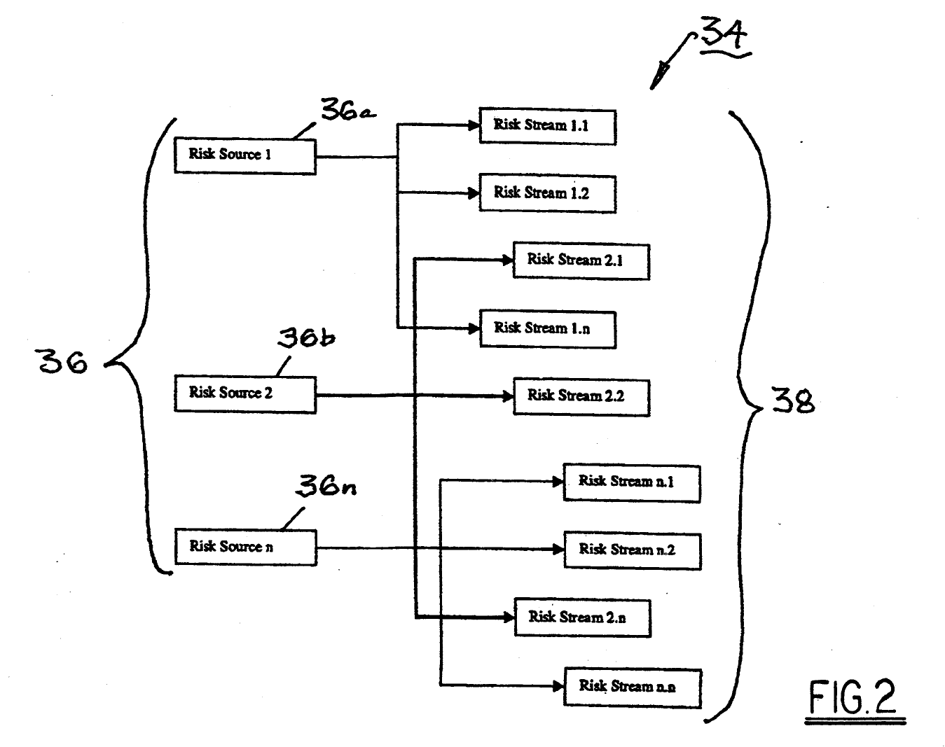

Referring now to FIGS. 1 through 2, an exemplary flow diagram 10 of RAM-IP in accordance with the present invention shows a 100% risk-based framework for overall project execution. From a Start 12 on Day One, Project Goals 14 are defined by the project owner in terms of product, quality, cost, and time. From these, Risk Mapping Customization (Risk Sources and Risk Streams) 16, Risk Control Strategies 18, and Key Risk Mitigation Activities (Control Steps) 20 are defined. Risk Ownership 22 is assigned for each Control Step 20. An Impact Analysis 24 is carried out for each of the assigned Risk Variables. As the project proceeds, Risks are continuously monitored 26 by the Project Control Manager, are entered into Project Progress and Project Health Reporting 28, and become the basis for Risk Reassessment and Management Changes 30 shall i) risk mapping, ii) risk control strategy, or iii)control steps be redefined following loop 32.

In a currently preferred embodiment, there are nine Sources of Risk: State, Local, and Municipal Agencies, Codes, and Approvals; Landlord Obligations, Approvals, and Communication; Design Development vs. Budget/Schedule; Scope Identification; Business Continuity; Contracting and Supply Chain; Construction Administration and Implementation; Transferable Risks; and Quality Control, Testing, and Commissioning. As shown in a Risk Registry in FIG. 1a, the nine Risk Sources are characterized by 32 Risk Streams spread over five project phases: Programming and Due Diligence; Pre-construction; Contracting Bid and Award; Construction; and Post-Construction.

Because the Risk Sources exist simultaneously, the Risk Streams also exist simultaneously. However, the Risk Streams may be organized chronologically or functionally in the sequence in which they must, or can, be addressed; e.g., the Risk Streams associated with Risk Sources 36a,36b . . . 36n may be chronologically or functionally organized as Risk Streams 1.1, 1.2, 2.1, 1.3, 2.2 . . . n.1, 2.3, n.3.

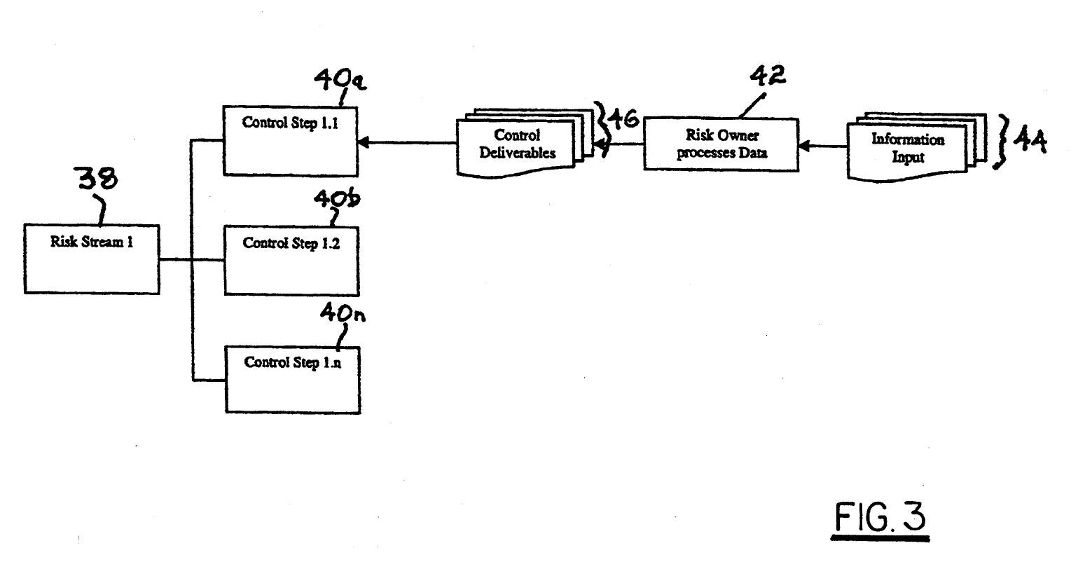

Referring to FIG. 3, each Risk Stream 38 is broken down into one or more critical Control Steps 40a,40b, . . . 40n, the proper management of which will mitigate the perceived risk in Risk Stream 38. Each Control Step is assigned a Risk Owner 42 who oversees the input and manipulation of information 44 to provide Control Deliverables 46 necessary to satisfy the output needs of Control Step 40a in mitigating risk in Risk Stream 38.

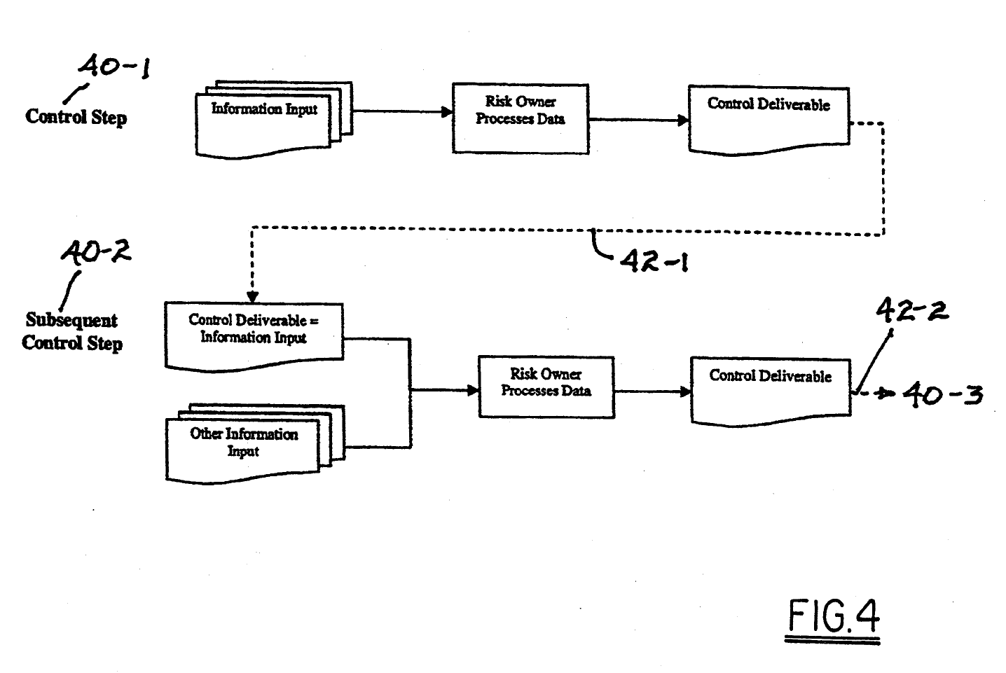

Referring to FIG. 4, the Control Steps 40 typically are not independent of one another, and the output 42-1 of one Control Step 40-1 may become critical input for a concurrent or subsequent Control Step 40-2, which may in turn become the input 42-2 for yet another control Step 40-3, etc.

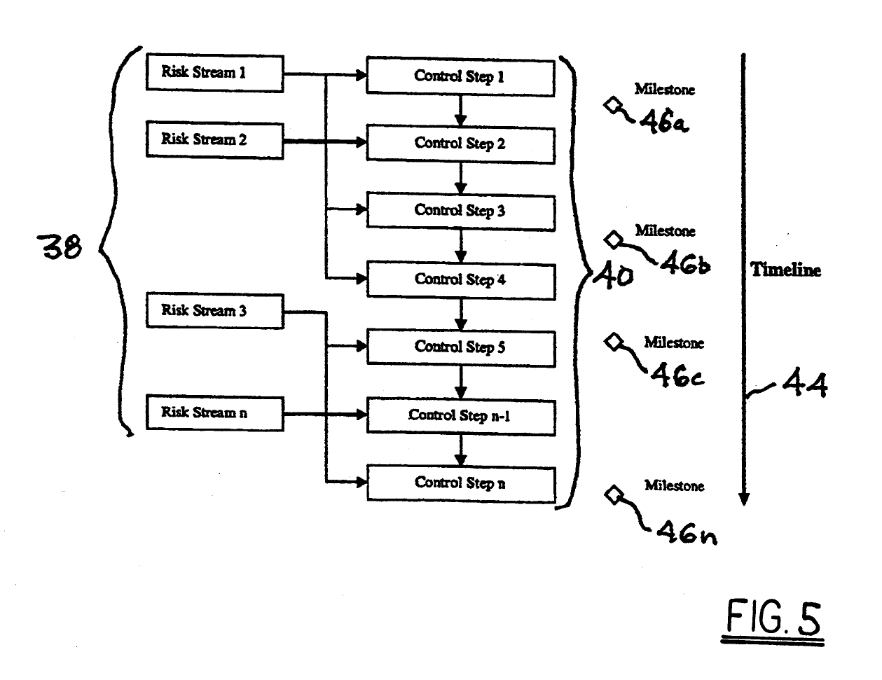

Referring to FIG. 5, similarly to the interleaving of Risk Streams 38 in FIG. 2, the 46a . . . 46n. Control Steps 40 as shown in FIG. 4 may similarly be interleaved, giving rise to a Project Timeline 44 based on a few Critical Milestones satisfied by completion of deliverables connected to given control step.

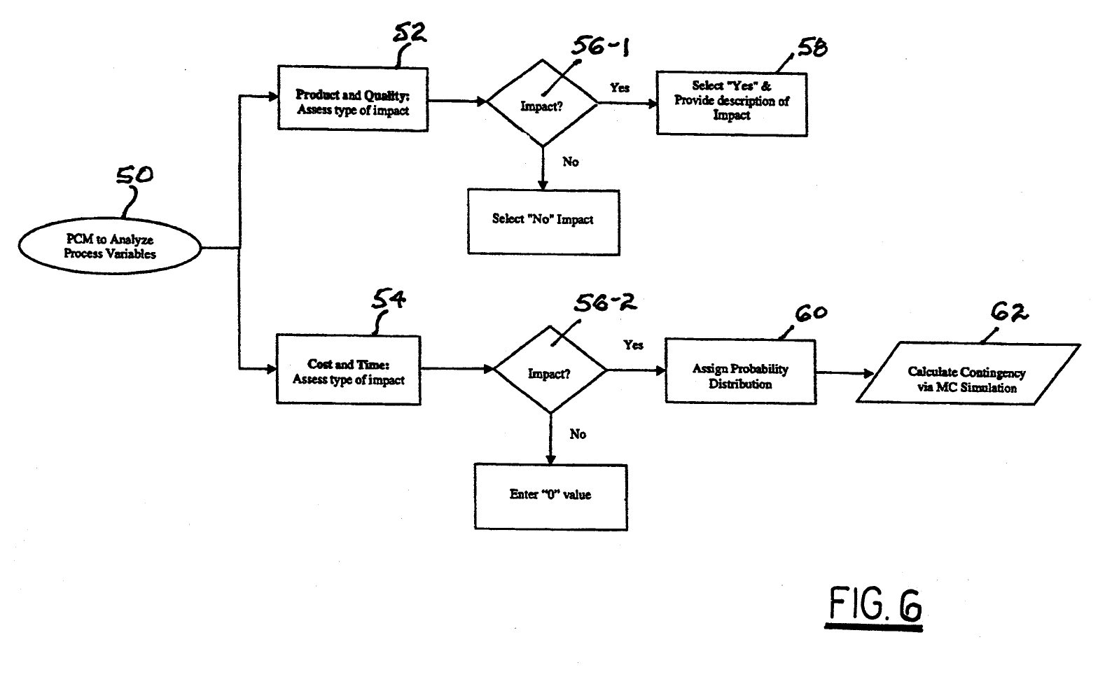

Referring to FIG. 6, the Project Control Manager 50 can analyze Process Variables of Product and Quality 52 and Cost and Time 54 in terms of the impact 56-1,56-2 each has on the advancement and success of the project. When Process Variables are determined to have an impact on Product and Quality, a description 58 of that impact, adverse or beneficial, will be provided. When Process Variables are determined to have an impact on Cost and Time of the project, a Probability Distribution 60 for that impact is developed, followed by calculated Contingencies 62.

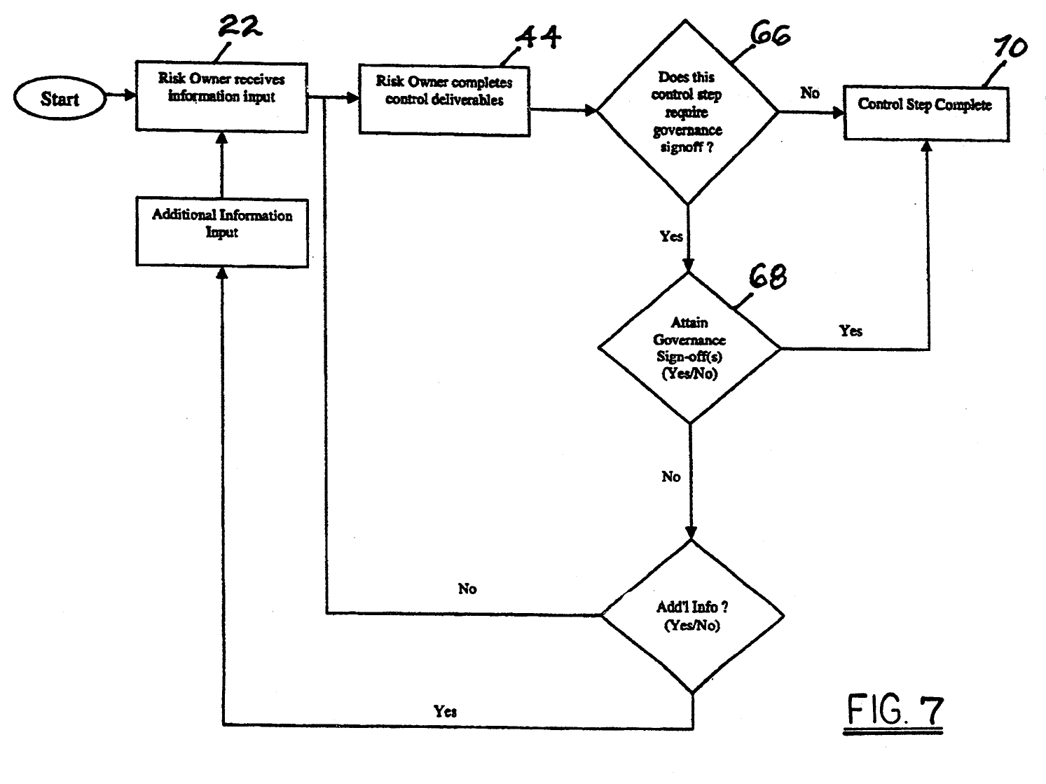

Referring to FIG. 7, to signify completion 70 of each Risk Step, the Risk Owner must complete the Control (Process) Deliverables 44. A Governance Officer 66 may or may not be required to sign off 68 that the Control Deliverables have been provided and the Risk Step is completed 70.

Tracking activities and progress in each of the RAM-IP steps shown in FIG. 1 and detailed in FIGS. 1a though 7 requires an elaborate computer spreadsheet architecture, preferably based on a commercially-available software such as Excel. Currently preferred subordinate spread sheets are RAM-IP Steps; Risk Registry (shown exemplarily in FIG. 1a); Project Control Worksheet; List of Deliverables; Probabilistic Analysis; Timeline; Project Cost Summary; Budgets—Base Costs; Base Contract Changes; and Invoicing—Payments.

From the foregoing description, it will be apparent that there has been provided an improved method for carrying out a complex project. Variations and modifications of the herein described method, in accordance with the invention, will undoubtedly suggest themselves to those skilled in this art. Accordingly, the foregoing description should be taken as illustrative and not in a limiting sense.

What is claimed is:

1. A computerized method for managing a project on a risk-management basis, comprising the steps of:
a) defining project goals;
b) breaking down risk into a plurality of sources of risk at day one;
c) breaking down said plurality of risk sources into a plurality of risk streams;
d) monitoring said plurality of risk streams;
e) utilizing said monitoring to report on project progress and project health;
f) reassessing said risk sources and risk streams based on said project progress and project health; and
g) adjusting said risk sources and risk streams as said project proceeds.

2. A computerized method in accordance with claim 1, comprising the further steps of:
a) developing risk control strategies;
b) defining risk mitigation activities;
c) assigning ownership for each of said risk streams;
d) breaking down each of said risk streams into one or more critical control steps; and
e) analyzing the impact of risk variables in terms of product, quality, cost, and time.

3. A computerized method in accordance with claim 1 wherein said steps b) through g) are carried out in real time with provisions for change management.

4. A computerized method in accordance with claim 2 wherein each of said control steps is assigned a risk owner.

5. A computerized method in accordance with claim 1 wherein the number of said risk sources is nine.

6. A computerized method in accordance with claim 1 wherein said risk sources are selected from the group consisting of State, Local, and Municipal Agencies, Codes, and Approvals; Landlord Obligations, Approvals, and Communication; Design Development vs. Budget/Schedule; Scope Identification; Business Continuity; Contracting and Supply Chain; Construction Administration and Implementation; Transferable Risks; and Quality Control, Testing, and Commissioning.

7. A computerized method in accordance with claim 1 wherein the number of said risk streams is thirty-two.

8. A computerized method in accordance with claim 2 wherein execution of said control steps gives rise to a project timeline based on critical milestones.

9. A computerized method in accordance with claim 2 wherein satisfactory execution of said control steps includes a governance function.

10. A computerized method in accordance with claim 2 wherein said steps are tracked via computer software.

11. A computerized method in accordance with claim 10 wherein said computer software includes a spreadsheet.

12. A computerized method in accordance with claim wherein said project includes any kind of human activity wherein a number of steps may be organized for achievement to reach a desired goal.
